(19) United States
(12) Patent Application Publication
(10) Pub. No.: US 2012/0234989 A1
(43) Pub. Date: Sep. 20, 2012

(54) Apparatus for collecting leaves and other items for removal

(75) Inventor: Vicki Perlman, Lynbrook, NY (US)

(73) Assignee: Happy Go Leafy Products, Inc., Lynbrook, NY (US)

(21) Appl. No.: 13/385,917

(22) Filed: Mar. 14, 2012

Related U.S. Application Data
(60) Provisional application No. 61/465,224, filed on Mar. 16, 2011.

(51) Int. Cl. B65B 67/12; F16B 2/06

(52) U.S. Cl. 248/101; 248/316.6

(57) ABSTRACT

An apparatus for collecting such items as leaves, debris or hair is constructed of an outer channel and an inner hoop frame. The outer channel frame and the inner hoop frame permits a trash bag to be attached between the two frames so that the apparatus is contoured to, envelopes and attaches to an opening of a bag. In this way items such as leaves or other debris can be swept into the bag with a portion of the device serving as a dustpan edge/shoveling ramp to accommodate the sweepings of the leaves or other items into the bag.

### RELATED APPLICATIONS

This is a nonprovisional application of a provisional application Serial No. 61/465,224 by Vicki Perlman filed Mar. 16, 2011

### BACKGROUND

### Field

The present disclosure relates to an apparatus for collecting and removing items such as leaves, debris, hair, etc. that typically fall on the ground and need to be collected and removed. In particular, the present disclosure relates to an apparatus that can be connected to a standard trash bag or used in conjunction with other refuse collection devices such as a paper shredder bin or a lawn mower grass catcher, to pick up and discard such items. The apparatus is economically efficient, easy to use, durable, stores compactly and can also be wall mounted for use as a trash receptacle.

Leaves, particularly on one's lawn, can be unsightly and difficult to effectively remove without expending a major amount of time. It would be desirable to be able to collect these leaves by providing a device that makes clean up chores more efficient, less time consuming and allows refuse to be handled in an effective, sanitary manner.

The apparatus is also effective in easing the cleanup and removal of construction and general debris by reducing repeated bending and lifting, reducing direct physical contact with the debris, and reducing the time and effort needed to sweep an area clean.

### SUMMARY

The present disclosure provides an apparatus for collecting such items as leaves, debris or hair by providing an apparatus that is contoured to envelope and securely attach to the open end of any large lawn, trash or contractor bag so that leaves or other debris can be swept into the bag with a portion of the device serving as a dustpan edge/shoveling ramp to accommodate the sweepings of the leaves, fine debris or other items into the bag. The apparatus secures the bag in the desired position by pressing the bag fabric between matching hoop and channel frames, constituting the “Press-Hoop Technology”

### BRIEF DESCRIPTION OF THE DRAWINGS

FIG. 1 shows the device of the present disclosure in assembled form;

FIG. 2 shows a partially exploded view of the device of the present disclosure;

FIG. 3 is a back view of the assembled device of the present disclosure;

FIG. 4 is a back view of the handle of the device of the present disclosure;

FIG. 5 shows the clips for optional spikes and optional wall mounting bracket for the device of the present disclosure;

FIG. 6 shows the assembled device of the present disclosure with the receptacle or bag attached between the inner hoop and outer channel frames of the device in use collecting debris;

FIG. 7 shows the assembled device of the present disclosure with the receptacle or bag attached between the inner hoop and outer channel frames of the device with the device being hung;

FIG. 8 shows the assembled device of the present disclosure with the receptacle as a shredder basket used in conjunction with the device;

FIG. 9 shows the assembled device of the present disclosure with the receptacle or bag attached between the inner hoop and outer channel frames of the device in use collecting leaves; and

FIG. 10 shows the assembled device of the present disclosure storing sports equipment.

### DESCRIPTION OF THE PREFERRED EMBODIMENT(S)

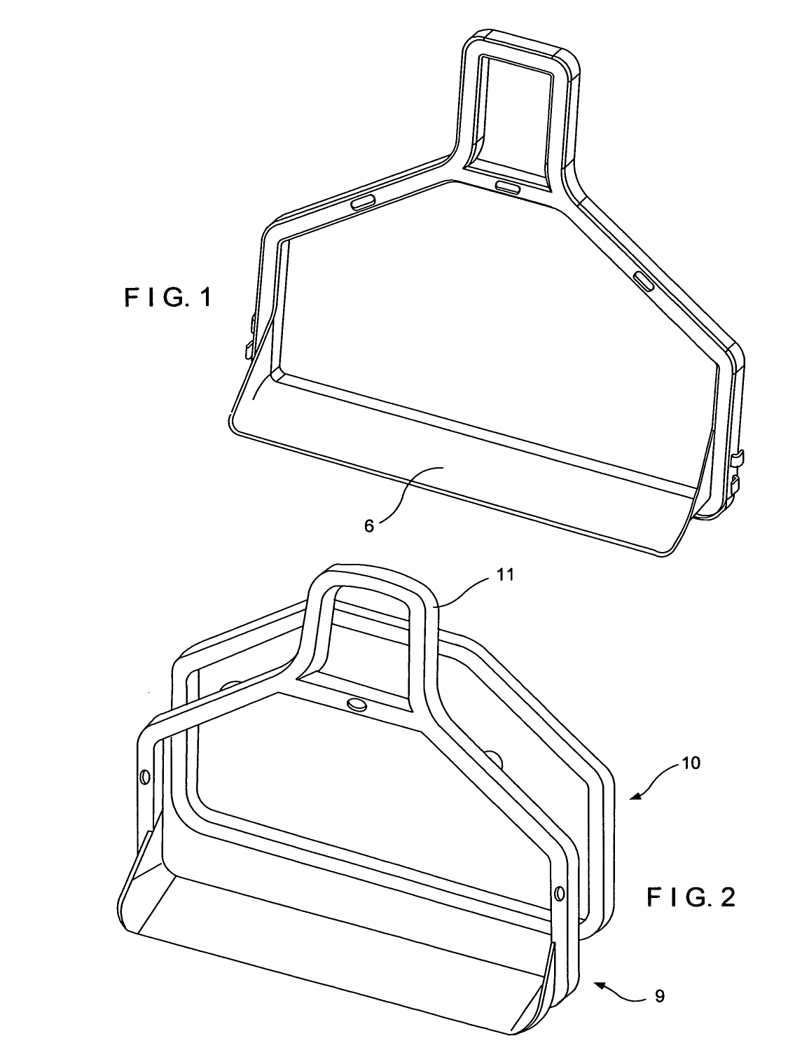

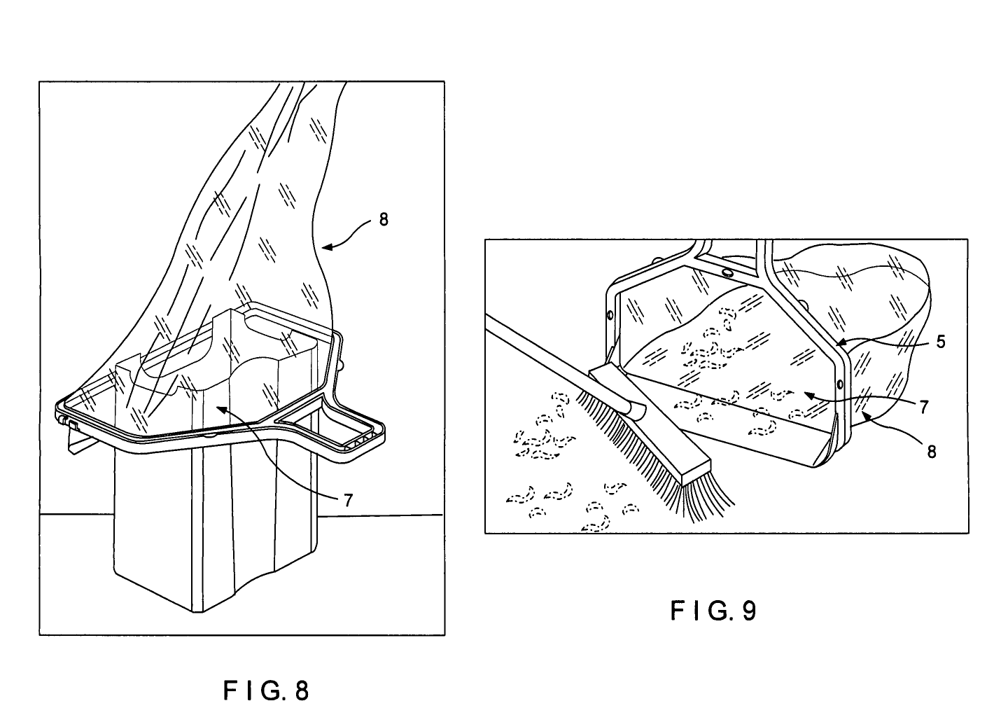

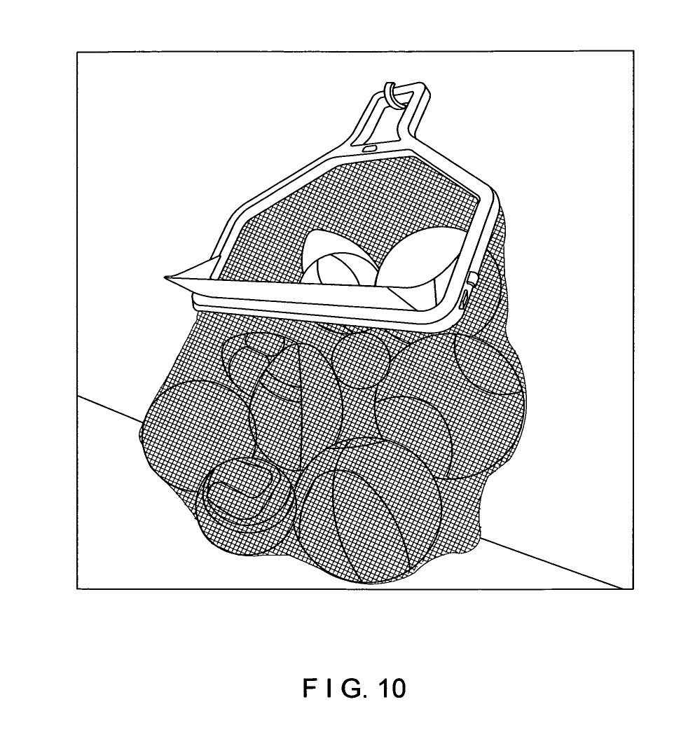

Referring now to the drawings of FIGS. 1-9, FIG. 1 shows the collection device 5 of the present disclosure. The device includes a dustpan edge/shoveling ramp 6 (FIGS. 2, 6 and 9) which angles downward to create a stable platform for a hands free operation in places where the staking mechanism is not an option. The device 5 is constructed to hold the mouth 7 of a receptacle 8 such as a trash bag 8 (FIGS. 7 and 8) open to facilitate sweeping of leaves, trash and other debris into the bag 8 (FIGS. 7 and 9).

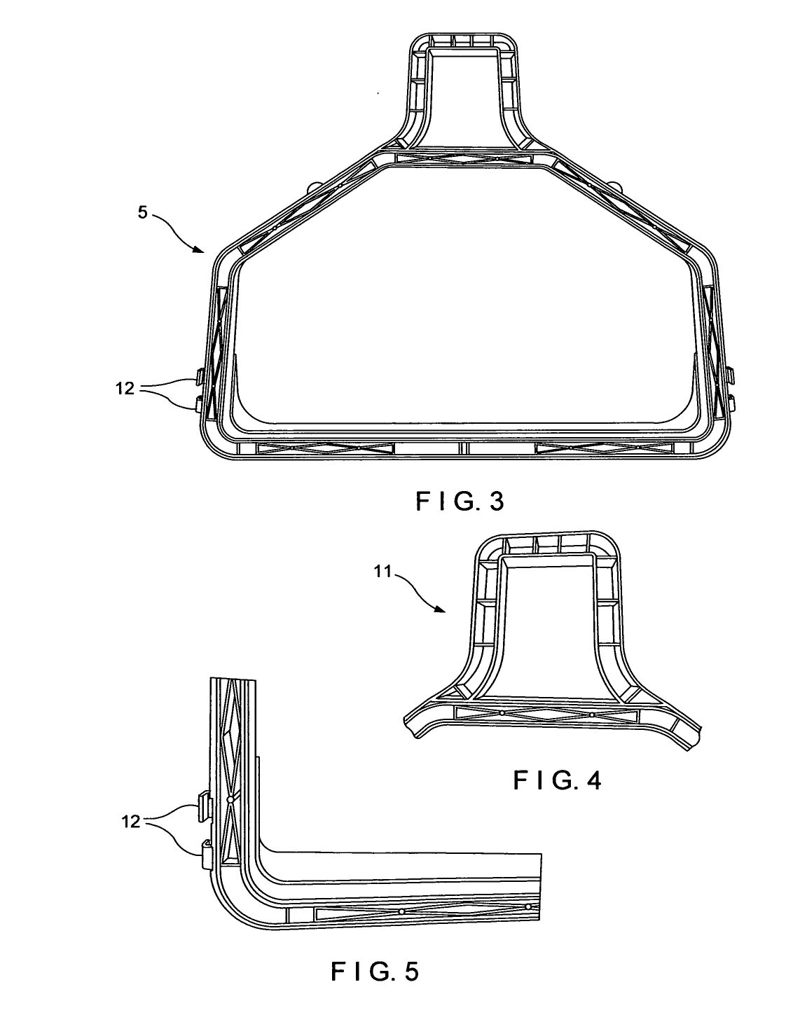

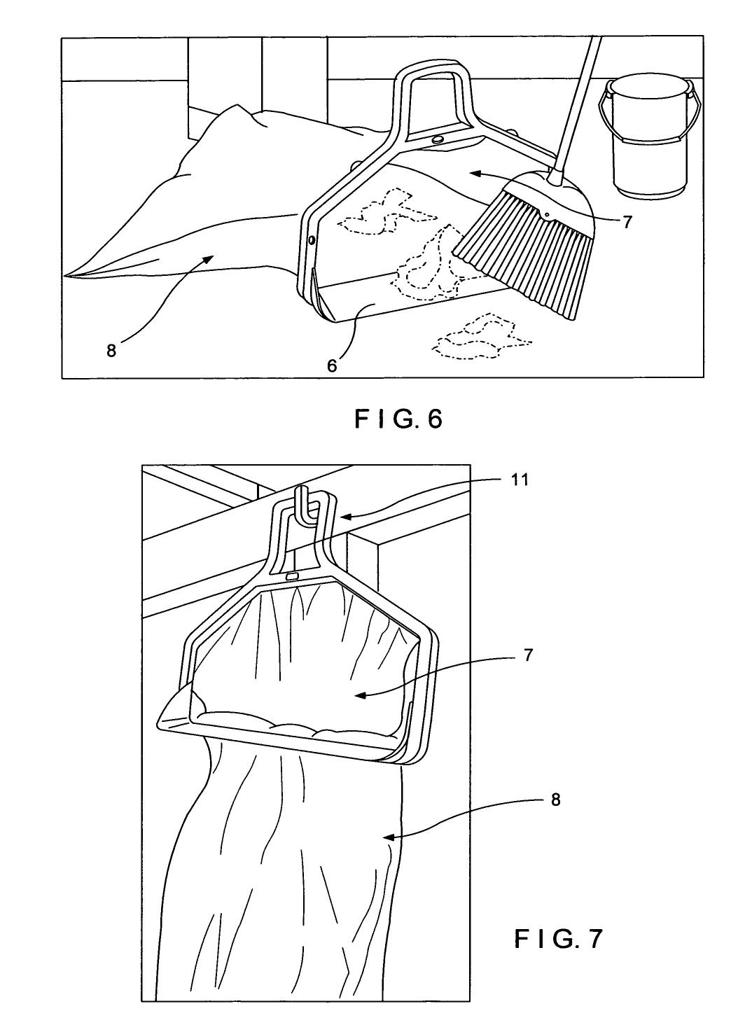

In addition, a wide range of commercially available flexible bags can be inserted through and then draped over the inner hoop frame 10 of the device 5. As seen in FIG. 2, the outer channel frame 9 of the device 5 is adapted to snap over the inner hoop frame 10 of the device 5 thereby securing the bag 8 between the frames 10, 11, holding the mouth 8 of the bag 8 open. The outer surface of the inner hoop frame and the inner surface of the outer channel frame incorporate a texture which increases friction between the bag and the apparatus. The outer channel frame 11 incorporates:
an angled dustpan edge/shoveling ramp 6 which eases the channeling of trash into the bag 8; an integrated handle 11 that minimizes bending of the user while sweeping; and fasteners 12 (FIGS. 3 and 5) that can accommodate ground stakes for securing the device into the ground when collecting items such as leaves into the device and the attached bag and/or a wall mounting bracket for hanging the device to a wall to convert the apparatus into a stationary receptacle for trash or recyclables (FIG. 7).

The unique design and shape of the device 5 affords the product flexibility and stability while maximizing the area available for sweeping up debris. In addition to trash bags, the dimensions and unique shape accommodate trash baskets, shredder baskets and lawn mower grass catchers. Other uses for the device of the present disclosure include:

Paper Shredder Baskets: A messy job is made much simpler and neater when you put the device 5 over the rim of the shredder basket and turn it upside down. All debris falls neatly into the trash bag 8. No mess. (FIG. 9).

Lawn Maintenance: Remove the lawn mower grass catcher bag from the lawn mower; place the device 5 over the top, turn upside down and empty clippings into trash bag 8.

Office Cleaning: Using the same procedure as above, many standard sized office trash baskets can be emptied into one large trash bag. The same is true for personal office shredders.

Household Clean Up: Basements and Garage debris can be swept clean with ease using a standard broom.

Construction Site and General Debris Removal: Contractors and cleaners can use the apparatus 5 in conjunction with standard contractor bags to ease and speed clean up of construction debris, sawdust and other trash left on the floor in an area that needs to be swept clean.

Stationary Trash Bin: By hanging on a hook or nail, or by utilizing an optional wall mounting bracket, the device 5 will function as a convenient disposal container. This is particularly useful for basement or garage areas.

Hair Salons: Beauty salons clean hair clippings from the floor multiple times a day. This device 5 can be used to sweep hair directly into a bag, it can be hung in an out of the way closet or back room and used all day long without the effort of having to constantly empty dustbins into trash containers. This bag can be removed at the end of the day or after several days, as needed.

Storage and transportation of toys, sporting goods: By utilizing an optional, durable mesh bag, the apparatus 5 can be used to neatly store and transport toys and sporting goods to destinations such as parks, playgrounds and beaches.

School Cafeteria and Grounds: Also churches, storefronts, synagogues and other commercial businesses can use the apparatus 5 in a myriad of ways as stated.

Eases composting of lawn and yard waste: If one puts one's lawn clippings and leaves at the curb one loses the opportunity to use them in one's home composting bins. This device 5 assists in recycling leaf and lawn clippings into rich fertile compost for your garden. Simply empty plastic collection bags into one's compost pile and reuse them over and over again. No waste!

The device 5 is suitable for year round clean up of store-fronts, driveways, garages, school yards, cafeterias, parks, playgrounds, etc. (FIG. 9).

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A device for facilitating a collection of items and/or debris into a receptacle, comprising:
said device including an outer channel frame and an inner hoop frame adapted to be disenagingly connected to each other, the outer channel frame of the device being adapted to snap or press over the inner hoop frame of the device thereby securing a receptacle bag between the frames, holding a mouth of the receptacle bag and open for collected items and/or debris to be deposited therein;

2. The device according to claim 1 wherein said receptacle is a bag;

3. The device according to claim 1 wherein said outer frame includes an angled dustpan edge/shoveling ramp that touches the ground to facilitate the collection of said items or debris into said receptacle;

4. The device according to claim 1 wherein said device further includes an integrated elongated handle to minimize bending by a user of the device while sweeping;

5. The device according to claim 1 wherein said device includes fasteners that can accommodate ground stakes for securing the device into the ground when collecting items such as leaves into the device and the attached receptacle;

6. The device according to claim 1 wherein said device includes a wall mounting bracket for hanging the device to a wall, thereby converting the device into a stationary receptacle when the device is stored away for future use.
